(19) United States
(12) Patent Application Publication
(10) Pub. No.: US 2008/0020814 A1
(43) Pub. Date: Jan. 24, 2008

(54) BROADBAND GAMING SYSTEM AND METHOD

(76) Inventor: Nicolas Kernene, St. Charles, IL (US)

Correspondence Address: OSTROLENK FABER GERB & SOFFEN, 1180 AVENUE OF THE AMERICAS, NEW YORK, NY, 100368403, US

(21) Appl. No.: 11/757,953

(22) Filed: Jun. 4, 2007

Related U.S. Application Data
(60) Provisional application No. 60/810,441, filed on Jun. 2, 2006.
(60) Provisional application No. 60/898,278, filed on Jan. 30, 2007.
(60) Provisional application No. 60/922,162, filed on Apr. 5, 2007.

(51) Int. Cl. A63F 9/24; G06F 21/22; H04N 7/16

(52) U.S. Cl. 463/10; 463/25; 725/25

(57) ABSTRACT

The invention includes a system and method for validating a selection made by a user in connection with a remote application. A video feed that includes at least one image is received from a video source. Corresponding video metadata that includes electronic information representing the at least one image in the video feed is received with the video feed. The video feed is transmitted to the user via a broadcaster, and the video metadata is transmitted to a data matching engine. Thereafter, the selection that is responsive to the video feed, is received from the user, and user metadata that includes electronic information representing the selection is transmitted to the data matching engine. The data matching engine provides matched metadata of the video metadata with the user metadata and the user's selection is validated as a function of cross-referencing the matched metadata and the video feed.

### CROSS-REFERENCE TO RELATED APPLICATIONS

This application is based upon and claims priority to U.S. Provisional Patent Application Ser. Nos. 60/810,441, filed on Jun. 2, 2006 and entitled BROADBAND GAMING SYSTEM AND METHOD, 60/898,278 filed on Jan. 30, 2007 and entitled BROADBAND GAMING SYSTEM AND METHOD II, and 60/922,162, filed on Apr. 5, 2007 and entitled BROADBAND GAMING SYSTEM AND METHOD III, the entirety of all of which are incorporated herein by reference.

### BACKGROUND

1. Field of the Invention

The present invention relates to middleware technology, and, more particularly, to security and validation with respect to remote user interactions.

2. Description of the Related Art

In known remote gaming operations, such as provided on television, players do not experience true casino game play. Typically, players use a system that employs a random number generator (RNG) and utilizes software to emulate a true game. In some known systems, televised gambling attempts to emulate a casino experience, but falls short of the excitement, and real time enthusiasm experienced by users. Unfortunately, the visual and emotional connection that players have with the live physical event that provides pleasure of playing a casino game is lost in known synthetic systems.

Notwithstanding these and other shortcomings, it is believed that consumer spending on online and/or remote gambling will at least double over the next five years. Further, the number of users of interactive television is similarly believed to at least double over the next five years.

It is further believed that gaming and betting has begun to take a foothold in the interactive television landscape. For example, SKY BET VEGAS broadcasts live roulette games from a studio, as well as virtual horse and dog racing, and live, presenter-led Keno games. Other live, interactive betting television channels are known.

In addition to televised gaming, internet web sites provide gaming ventures for visitors. These games operate similarly to physical casino games, in that one dealer can service a limited number of customers simultaneously.

In some known systems, a telephone line is connected to a customer's television proprietary set top box, and facilitates two way communication from the customer's television. A customer typically pays for the use of the dedicated telephone line in order to access games and/or special programming. In another known system, a customer purchases a special antenna that is placed on the customer's home roof to enable access to the programming.

Traditionally, middleware companies in the cable television industry enable end users of a network to communicate. Examples of middleware companies include TIVO, OPENTELEVISION, SEIMANNS, and ELECTRONIC PROGRAMMING GUIDE, ADTEC, BITBAND, EDGE STREAM, and NDS GROUP. Known television networks provide a medium for shoppers to purchase goods using their televisions that has a potential of becoming a more universally trusted market place. For example, people over fifty years old, people who are not computer proficient, and/or people who have lost trust in the internet as a secure environment are more inclined to trust existing cable television networks over the internet.

Furthermore, some reality-based television shows offer at-home or other voting via placing calls on cellular telephones that use one or more particular cellular service providers. Unfortunately, cellular phone fees associated with such votes can be very expensive (e.g., range from four dollars to nine dollars) for such services, with much of the proceeds being retained by the cellular telephone service provider. Alternatively, voting takes place on “land-line” telephones, and high charges are similarly charged. Thus, parties that provide such programming do not enjoy most of the proceeds raised from customers' casting votes.

It is believed that interactive television will suffer a major setback as many early adopters and new customers who have high expectations will become disappointed that their expectations are not met. Thus, consumer frustration with interactive television will increase substantially as its use increases.

The explosive growth of e-commerce and online banking is only surpassed by the growing losses attributed to security and privacy fraud. During the past five years, e-commerce and online banking have undergone massive growth and major challenges. Millions of people bank online and make online purchases. The number of users of electronic financial applications, on-line banking applications and e-commerce applications continues to grow.

Privacy and security remain important components of industry growth for e-retailers and their customers. Despite the significant market growth, consumers remain apprehensive about using a debit card or credit card to order goods on-line. A lack of consumer confidence combined with estimates of loss attributed to privacy and security fraud results in a setback for the industry. Furthermore, although the financial industry continues to benefit from robust online banking transactions, an impact is felt that is due to revenue loss and an erosion of consumer confidence from ineffective security measures that continue to allow fraud and piracy.

Further, fraud and security breach losses are not just a part of big business; they are big barriers to business. Businesses, manufacturers, trade and consumer associations and governments worldwide spend millions of dollars publicizing, packaging and advertising whenever they add new security measures or enact new safety, privacy and anti-fraud standards. Businesses must regularly invest in the reliability and the security of their e-commerce, data sharing, and payment methods, in part to persuade their customers that critical data are kept safe.

### SUMMARY

Preferably, a system and method for validating a selection made by a user in connection with a remote application is provided. A video feed that includes at least one image is received from a video source. Corresponding video metadata is received with the video feed that includes electronic information representing the image(s) in the video feed. The video feed is transmitted to the user via a broadcaster, and the video metadata is transmitted to a data matching engine. Thereafter, the selection that is responsive to the video feed is received from the user, and user metadata that includes electronic information representing the selection is transmitted to the data matching engine. The data matching engine provides matched metadata of the video metadata with the user metadata and the user's selection is validated as a function of cross-referencing the matched metadata and the video feed.

In another aspect, a wager is executed by a user in connection with a remote gaming application. Preferably, an electronic financial account is maintained for the user that is operable to debit the wager and further to credit proceeds from the wager. Moreover, a video feed is received from a gaming location, and the video feed includes game action images representing live game action occurring at the gaming location. Moreover, corresponding video metadata is received with the video feed, wherein the video metadata includes electronic information representing the images in the video feed. The video feed is transmitted to the user via a broadcaster, and the video metadata is transmitted to a data matching engine. Thereafter, the wager is received from the user, wherein the wager includes an amount directed by the user to be placed on the live game action represented in the video feed. The data matching engine receives user metadata that includes electronic information representing the wager, and the data matching engine matches the video metadata with the user metadata to provide matched metadata. Thereafter, the wager is executed based on the matched metadata and a rule associated with the live game action.

Preferably, a middleware application and corresponding data security protocol are provided that ensure secure, efficient and convenient operations for remote end-users. In accordance with preferred embodiments, a core middleware technology is provided that includes at least a matching engine that receives metadata representing a video feed, and further receives second metadata that represents a respective customer. The matching engine matches the two sources of metadata. In one embodiment, a physical hardware architecture is provided that utilizes a cable television infrastructure that is supported by multiple system operators. Other embodiments include an implementation that utilizes satellite television and cellular telephone technology.

In another embodiment, a back-office technology is provided that includes a data storage element for storing digital video, video metadata, customer metadata and/or sequenced customer metadata with video metadata. The various data that are stored are preferably consistently available for access for a customer service operation. In this way, customer service is provided with current and accurate data for problem resolution, responding to customer questions, and confirmation of transactions.

Further, disclosed is a financial transaction application that is operable to support a complete financial transaction, from start to finish. Sellers and purchasers alike preferably utilize the core middleware technology and back-office technology described herein for offering and/or selecting items and services for sale, and financial elements of the transaction are securely made without a threat of individual or corporate piracy. Further, the financial transaction application provided herein is operable for cable-television shopping. In another application, electronic and remote voting is provided in a secure fashion, and fees associated with voting, for example, during an interactive game are maintained under control by a proprietor of the systems and methods described herein.

Another feature disclosed herein regards location-dependent applications that ensure compliance with various legal standards. For example, a gambling/gaming application is supported in which various activities occur legally in respective locations and that are controlled by the middleware and topology described herein. For example, a remote user of the systems and methods described herein place wagers using his/her television set, and due to a particular data management protocol, the wager is executed outside of the user's home. Further, the identity of the player, the location of the player, the time a wager is placed, and the amount of a wager are validated. In another application, election voting is available via the systems and methods herein as function of validating the identity of the voter, validating the location where a vote is cast, validating the time a vote is cast and restricting voters to a single vote. Preferably, any activity or event that occurs and in which specific location information is desired, such as voting, gaming, and state taxation is applicable and benefit with the teachings herein.

In another embodiment, bridging internet transactions to secured cable systems is provided. Moreover, internet transactions are bridged over to secured satellite or mobile transmissions in accordance with the teachings herein. A bridging feature is provided wherein the topography of the internet is bridged to a cable multiple systems operator. Alternatively, bridging is provided for satellite television providers and cellular telephone providers.

Thus, the features and advantages of the systems and methods provided herein are supported at least in part by a media matching engine, a data matching engine, an internet security bridge and a video validation protocol. Moreover, non-recursive, non-pattern generating signatures are provided, thereby precluding any party that attempts to eavesdrop or otherwise intercept transmissions set forth herein gains no meaningful access to information. Accordingly, data are preferably filtered such that only reference information is transmitted and that identifying data, such as names, addresses, bank accounts or other personally identifying information, which may be used by unscrupulous parties, are not transmitted.

In yet another embodiment, time delay functionality is built into transmissions that guarantees the topology of least upper bound for the delay signatures. With regard to cellular telephone technology, cell switching delay methods are provided to guarantee that a transaction occurs in a single cell, at a single cell tower.

Other features and advantages will become apparent from the following description that refers to the accompanying drawings.

### BRIEF DESCRIPTION OF THE DRAWING(S)

For the purpose of illustration, there is shown in the drawings a form which is presently preferred, it being understood, however, that the invention is not limited to the precise arrangements and instrumentalities shown. The features and advantages of the descriptions herein will become apparent from the following description that refers to the accompanying drawings, in which:

FIG. 1 illustrates an example hardware arrangement associated with an embodiment;

FIG. 2 illustrates a more detailed example arrangement of hardware and parties associated with the embodiment of FIG. 1;

FIG. 3 is a flow chart that illustrates steps associated with securely providing a remote gaming channel and for receiving and executing a wager according to an embodiment;

FIGS. 4A-4D illustrate an example flow of information and order of operation in accordance with an alternative embodiment;

FIG. 5 shows an example display screen that is provided on a customer's television set in accordance with an embodiment;

FIG. 6 illustrates example displays that include a remotely operable playboard, and that is operable for a customer to make game and screen selections;

FIG. 7 illustrates another example arrangement including an example flow of information and order of operation in accordance with an alternative embodiment; and

FIG. 8 shows an example arrangement and example flow of information in accordance with an alternative embodiment.

### DESCRIPTION OF EMBODIMENTS

Preferably, various example embodiments are disclosed herein that utilize various aspects of the teachings herein. One embodiment includes a platform including a middleware hardware and software component that operates to provide a secure and convenient system and method for users to send and receive information, for example, using their televisions, or other home media system, over a communications network. The middleware hardware and software component supports many kinds of applications that require secure and verifiable transactions. For example, the middleware technology is operable to verify a person's actions and intentions, and accurately identifies particular content that was displayed at a particular point in time when the person acted upon his/her intentions. In this way, a new standard in data security is defined that supports, for example, financial transactions, voting, data validation, legal video records, and is simple to integrate into existing infrastructures.

In an embodiment, an implemented television network directed to gambling and casino games, and which preferably utilizes the middleware topology is provided. The implemented network provides secure financial transactions and gaming over existing non-internet technologies. Preferably, users (also referred to as “customers”) use an interactive cable or other television service and receive a live digital video feed from a casino or other gaming establishment. The video feed is transmitted to the customers and information about the video is sent to a location in the cable infrastructure that is local to the customers, but not at the customers' locations. This location is referred to herein, generally, as the central office, and may be located at several points in the cable infrastructure. As used herein, the term, “central office” further refers to a common reception point where a plurality of transmissions from respective sources is received. For example, cable transmissions from a plurality of homes are received and aggregated at the central office. In a preferred embodiment, the central office is operable to execute instructions, such as programmed script or computer executable code. Moreover, the central office is preferably the first point of concentration of the topology of cable, “upstream” from the users to the cable provider.

For example, the central office may include a cable provider's local loop, the distribution hub, the super hub, the regional center, or the head end, as known in the art. The customers preferably send selections (e.g., representing gambling bets) to the central office. The bets are preferably validated at the central office.

A computing device, such as a server computer and as known in the art, is located at the central office and preferably operates as a gaming server. Preferably, a customer or other end user submits proper authorization in order to access the gaming server. In an alternative embodiment, a program script that is executable in the memory of one or more electronic devices in a cable infrastructure operates to provide gaming activities. The one or more electronic devices are preferably located at points in the cable television infrastructure where data from individual locations can be monitored. For example, a matrix switch, a fiber channel array, and other routing points, as known in the art, execute program script to provide features described herein.

Preferably, the computing device monitors and records customer's selections. In one embodiment, a casino preferably provides a real time feed of live game play, and another server device located at the casino or other gaming establishment records and monitors customer activity. In this way, broadcast activity in a gaming establishment is provided, and remote customers' selections are received and monitored, thereby enabling customers to participate in the games, substantially in real time. Further and preferably, real time help is offered to the end user. Moreover, auditing of the activities is also available substantially in real time. Thus, an audit trail is preferably provided that represents customer actions that occur as close in time to a defined event as may be electronically recorded. Accordingly, live gaming occurs at a casino or gaming establishment, and a home user, using an interface with his or her cable or other television service, interacts with the casino or gaming service substantially in real time.

As described below and shown in the reference figures, customers are provided with a full production entertainment experience that includes live gaming and various casino-related activities such as live entertainment performances. Moreover, financial transactions and other logistics are preferably handled using the technological infrastructure described herein.

Preferably, an easy, secure and fast way for end-users to transmit various information using televisions, or other home media systems is provided. Using the infrastructure described herein, a person's request, location, and time are validated, and problems, such as those that associated with Internet Protocol Television (“IPTELEVISION”), are precluded.

In one embodiment, a middleware and secure data protocol described herein offers an ability for remote voting to happen immediately, for example, via a television, and operates to validate a user's identity and eliminate issues, such as related to casting multiple votes. Moreover, profits are channeled to the program and/or channel, and not to a third party carrier, such as a cellular telephone service provider.

Moreover, response times are dramatically improved and wait times during data transmission are reduced. Further, the processes described herein add value and are operable to generate revenue in cable markets that are concerned with secure financial transactions by recording and tracking a person, location, time, and sequence of events.

Moreover and as described in greater detail below, transmission and safe handling of various records, such as confidential legal records, medical records, insurance, financial records or the like, is provided.

Many different applications are supported by the teachings herein, including but not limited, to applications in which secure, fast and/or easy transmission of information, particularly confidential information, is provided to an end-user using a television set. For example, implementations are envisioned for the healthcare industry, records handling industry, and e-commerce applications. Value is preferably added to any system able to benefit from securely capturing and tracking, for example, a person's, selections, bets, transactions, or intentions, and, thereafter, validating those intentions against what the person saw on their screen at they time they acted upon those intentions. Preferably, any activity or event that occurs and in which specific location information is desired, such as voting, gaming, and state taxation is applicable and benefit with the teachings herein.

Further, it is envisioned that an implementation for local governments to offer customers to cast election votes from their homes is supported. This is believed to be particularly useful for customers who may be homebound, such as the elderly or disabled, or for people would otherwise not be comfortable managing through the internet. Further, people are able to use their television sets to access their medical, insurance, and legal documents in a safe manner beyond known methods, such as using web sites, email, or even parcel post. Virtually any e-commerce application is supported, from home shopping channels to impulse purchasing of branded merchandise, shown in a typical broadcast commercial in a fast, secure and simple to use platform.

In one embodiment, live digital video feed is synchronized with real time auditing data that represents a person's actions, graphical screen control selections, indications, and/or financial purchases. A data audit trail is preferably instantly generated that corresponds to a person's activities to during a real-time event that is substantially simultaneously shown via digital video transmission. Preferably, small-sized data elements and/or small quantities of data elements are transmitted from a channel that consequently trigger applications and/or graphics for the user to select. In one embodiment, the term, “channel” refers generally to a full cable station, a sub-channel on a station, or and interactive add-in to an existing channel, as known in the art.

As will be clear to one skilled in the art, a new technology that greatly improves the speed of data transactions by enabling the transport of large amounts of information without a requirement for transmitting large quantities of data is provided herein. This preferably occurs as a function of metadata that represents and correlates with associated digital video data. By transmitting corresponding metadata and not the corresponding digital video, which requires significantly more bandwidth, performance is substantially faster than prior art transmissions.

Moreover, a new way is provided for a person to commit a transaction, for example, from his home using a television set (or other media device), and have that transaction legally completed in the same jurisdiction, but not in the customer's home. Alternatively, a transaction is completed in a respective jurisdiction that is not necessarily in the same jurisdiction where that person's home (or television set) is located. Thus, the user has no direct access to the system from his home or from, for example, a web browser operating on the internet.

Furthermore, and in the case of casting election or other votes, users are enabled to cast votes immediately and via a television. Preferably, the user's identity is validated, and fraudulent activity, such as casting multiple votes or casting a vote for a different voter, is eliminated. Moreover, and unlike prior art private entertainment voting applications, revenue associated with casting votes is not realized by cellular telephone service providers or other carriers, but is instead realized by the party or parties providing a respective program, television channel, and/or the like.

In a preferred embodiment, a customer's identity is securely authenticated prior to the customer being allowed access to at least some of the systems and methods described herein. In one embodiment, an individual's identity is provided as a function of fingerprint authentication. By requiring a fingerprint to be read by a device in order to verify the identity of a user, security is enhanced and fraud is eliminated. Thus, in a preferred embodiment, a customer begins a session by proving his identity with a fingerprint authentication process. One or more fingerprint reading devices are preferably provided to the customer that are operable to read and confirm the identity of the person. Other identity applications are further envisioned, such as retina scan devices or voice authentication applications.

Preferably, a data security architecture is provided herein. The data security architecture is operable for many applications, such as for financial transactions, voting, data validation and submitting legal video records. Video records, in particular, are typically challenged in the prior art due to unaccepted compression techniques that “draw” extra frames of pictures to fill in the gaps. By drawing extra frames, the video content may be unreliable. The middleware and secure data protocol described herein, however, preferably uses standard lossless compression, as known in the art, and no video data is lost or drawn.

Moreover, a new combination and arrangement of hardware and software is provided that implements the data security standard. Referred to herein and shown in the reference figures as a “media matching engine,” a hardware and software arrangement can be easily integrated and customized for various so-called “vertical” applications. The media matching engine is relatively easy to add to existing infrastructures, thereby reducing extremely high costs associated with integrating enterprise resource planning applications. Moreover, a new security protocol is defined herein that extends far beyond the internet with regard to encryption and source validation, and, accordingly, the middleware and secure data protocol described herein represents a new generation of security. In a preferred embodiment, a matrix switch is used for data matching engine that ensures costs associated with the “last mile” of video and/or data distribution are very manageable. Further, due to the ease of integration of the protocol and methods described herein, the platform is capable of being customized and licensed for various industries and uses.

The way in which customers interact with the systems and methods described herein creates an accurate audit trail. Moreover, the size and amount of data transmitted is very small, thereby improving speed and accuracy of data transactions. This occurs, in part, by filtering redundant or other information and by sending small amounts of data.

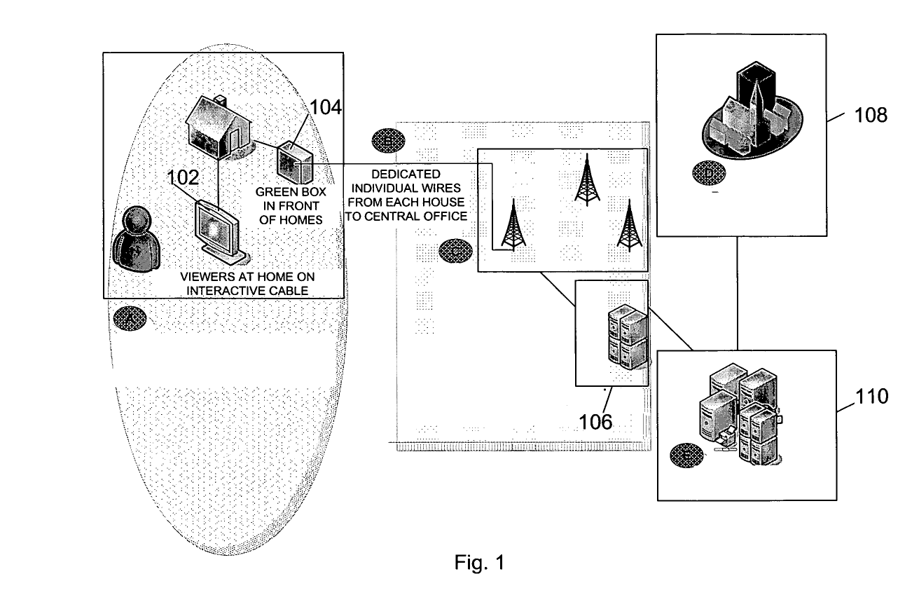

Referring now to the figures, in which like reference numerals refer to like elements, FIG. 1 illustrates an example hardware arrangement associated with an embodiment. A customer operates a television 102 that is preferably connected to a neighborhood's green box 104. Alternatively, a local ring, Hybrid Fiber Copper (“HFC”) ring, fiber branch or the like, may be used to receive video feed from a local central office 106 for distribution to respective cable subscribers within the neighborhood. In practice, a customer executes a transaction, such as placing a bet. The video feed originates from a casino 108, and transmitted to one or more media asset management servers 110 that are preferably controlled by a proprietor of the systems and methods described herein. In accordance with the teachings herein, media asset management servers 110 may include a plurality of computing devices.

As video data is sent to a customer, only a small amount of data about the video is sent to the central office 106. The central office 106 is preferably part of an existing cable infrastructure and is a direct physical link to a home or other end-location with a secure, point-to-point connection that cannot be spoofed or imitated by someone at another location or on the internet. Moreover, data sent from a customer, such as a selection, a request, or a bet is also sent to the central office 106. Information about the video is preferably matched at the central office 106 with the information from the customer. The customer's intent is paired up with the content that was displayed to the customer at the time the customer acted. The pairing represents the completion of the transaction. The transaction is legally completed quickly, safely, and in the same legal jurisdiction as the customer's home. Moreover, the entire process takes place substantially in real time.

Information regarding a completed transaction is preferably securely stored and can be retrieved, for example, for real-time help and auditing. Security is provided by validating a person's request, location and time against a video audit trail of a live event, and data are checked and entered into the system in a location outside of the home. Such a feature is not known to be able to exist on the internet.

Moreover, response times are improved because the amount of data that are transmitted is reduced. Additionally, usability is enhanced with hassle-free interaction and an availability of real-time customer service. The result is a realistic and convenient user experience.

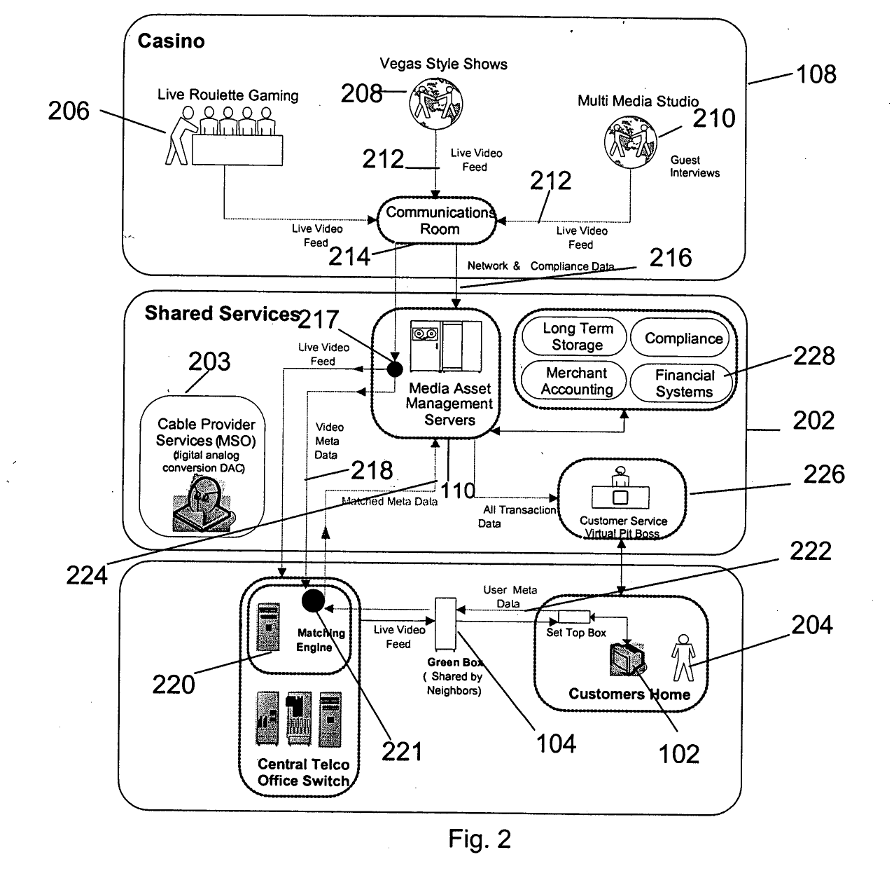

FIG. 2 illustrates a more detailed example arrangement of hardware and parties associated with the embodiment of FIG. 1. As shown in FIG. 2, casino 108, shared services 202 and customers 204 are arranged to transmit and receive video and/or data there-between. Shared services 202 are preferably provided, at least in part, by multiple system operator 203, such as a cable television provider. Preferably, multiple system operator 203 employs digital/analog conversion techniques to operate on video feed 212 and/or video metadata 218. Casino 108 includes live gaming 206, such as live roulette gaming, entertainment shows 208, such as Las Vegas style shows, and a multi-media studio 210, such as provided for guest interviews and other productions. Video feed 212 from the respective areas of the casino 108 is preferably transmitted to communications room 214. Video feed 212 is preferably digital video and is correlated with data, including video metadata 218, representing information such as time, place and location in the video images. Video feed 212 is preferably transmitted to media asset and management server 110, as are network and compliance data 216. Media asset and management server 110 preferably combines the live game play video 212 with video metadata 218 frames, and separates the video metadata 218 from the live video feed 212. In a preferred embodiment, video matching engine 217 is provide within media asset and management server and matches video feed 212 with video metadata 218.

Continuing with reference to FIG. 2, video feed 212 from the live game play 206 in casino 108 is forwarded from the media asset and management server 110 to a data matching engine 221, which is preferably provided with processor 220. Moreover, as customer 204 signs in to the systems and methods described herein, customer metadata 222 is similarly forwarded to data matching engine 221 (also referred to herein and/or shown in the figures as a “betting matching engine”). Preferably, data matching engine 221 matches video metadata 218 with customer metadata 222 and, for example, determines the status of the game. Further, data matching engine 221 forwards the matched video metadata 218 and user metadata 222 to media asset management server 110, and stores combined information in a database. In this way, live game status information, player information and event information, such as a user placing a bet, are validated and stored. Further, data matching engine 221 and/or media asset management server 110 use time-stamping hardware and software applications to assure compliance with various rules, such as associated with voting, placing a wager or the like.

Continuing with reference to FIG. 2, customer service/virtual pit boss 226 is preferably provided for assistance with customer 204 before, during and after a transaction occurs. In a preferred embodiment, transaction data that represents one or more of the video feed 212, video metadata 218 and customer metadata 222 is available to customer service personnel 226 so that accurate and up-to-date information can be provided to customer 204. Moreover, customer service 226 may function or appear as a virtual pit boss and emulate a pit boss in a physical casino 108.

Moreover, database 228 is provided that stores, for example, archived data, network compliance data, merchant accounting data and financial systems data. By integrating a variety of current and historical data in database 228, a large variety of applications can be supported by shared services 202.

In a preferred embodiment, and as described in greater detail below, media asset management is provided and replaces cost-prohibitive integration of, for example, customized or proprietary enterprise resource planning applications. In typical prior art installations of enterprise resource planning (“ERP”) applications, as known in the art, often result in a customer incurring substantial fees. Expenses in the tens of millions of dollars of hidden costs for EAI (enterprise application integration) are not uncommon in multiple large-scale applications that require integration (to be able to share) and share information. The union of media matching engine 217 with data matching engine 221, as described herein, provides a sort of universal card catalog system, in which multiple applications can draw from, store, and relate, data cataloged from multiple sources.

The systems and methods described herein provide for the ability to place and validate a wager in customers' 204 respective jurisdictions, but not in the homes or physical locations where wagers are placed. Data matching engine 221 is operable to track user activity in relation to video feed, and tracking user response to video is provided without a need for a return feed of the video. Moreover, software is provided for freeze-on-demand help screens during game play 206. In this way, video transmission of live gaming 206 or other content is paused while a help screen or other display is reviewed by customer 204. The transmission preferably resumes from the point where play was paused.

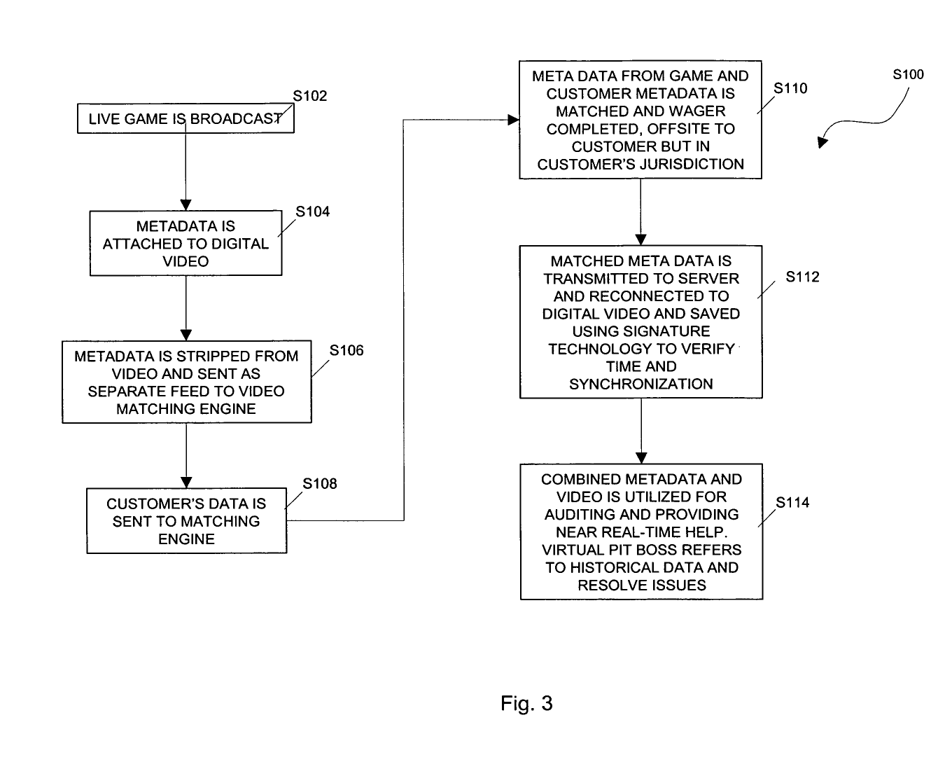

FIG. 3 is a flow chart that illustrates steps S100 associated with securely providing a remote gaming channel and for receiving and executing a wager according to an embodiment. At step S102, a live game, such as roulette, is broadcast from a casino 108. Typically, live game play is provided with commentary and other casino features, such as celebrity spotlights, audience participation, games and voting. As noted above, the show is preferably produced in communications room 214. Thereafter, at step S204, video metadata 218 is attached to digital video feed 212. At step S206, video metadata 218 is stripped from video 218 and sent as a separate feed to data matching engine 221. At step S208, customer metadata 222 is transmitted to data matching engine 221. The customer metadata 222 includes, for example, a wager made by customer 204 for a respective game. Thereafter, the video metadata 218 from the game and customer metadata 222 is matched and the customer's 204 wager is completed (step S210). Accordingly, the wager is completed off-site from customer 204, but within the customer's 204 jurisdiction. Thus, no wagering takes place within the customer's 204 home.

Continuing with reference to FIG. 3, at step S212, matched metadata (representing the video metadata 218 and corresponding customer metadata 222) is transmitted to a server, and the matched metadata are reconnected to the digital video, and preferably saved using signature technology to verify time and synchronization. At step S214, combined matched metadata and video is retrieved and otherwise utilized for auditing purposes. Moreover, customer service and help is provided as a function of the historical data, for example, to resolve issues and answer questions. In one embodiment, customer service 226 is provided in the form of a virtual pit boss and operates much in the same manner as a pit boss does in a physical casino 108.

In an embodiment, a virtual gaming environment is provided that is safe, regulated, and has a legal audit trail. Preferably, no proprietary set top box or other add-on device, for example, that requires a dedicated telephone connection is required in the home. In one embodiment, only an input device such as a mouse or joystick, a login ID and a password, and his encrypted identification key is used to safely and securely access and enjoy virtual gaming in accordance with the teachings herein.

In various embodiments, one or more games are provided to remote customers 208. Examples include roulette based on a live casino game 206, high jackpot tournaments, player-created tournaments, progressive games, lottery and drawing based on roulette results, and wagering on players at an actual casino table game 206 inside a casino 108.

Beyond avid gamblers, the systems and methods provided herein appeal to a mass market, including those customers 204 who may be less technically inclined or less inclined to otherwise frequent a casino 108. While experienced gamblers with more disposable income may focus on each spin of a roulette wheel, senior citizens and infrequent or less experienced players are likely to participate in daily, weekly, monthly or even annual tournaments. Such tournaments are believed to afford those people with less disposable income a chance to win large jackpots for a small entry fee. As will become clear to one skilled in the art, jackpots in accordance with certain games 206 are preferably determined by the number of entrants.

In one embodiment, lottery games are provided for senior citizens and young adults alike who hope to win a large jackpot, which is determined by the number of participants. Unlike typical lotteries, in which a player purchases a ticket and then watches the number drawing on television for a few minutes, multiple players compete for a large jackpot and watch for extended periods, such as a full hour. The entertaining nature of the show captivates the audience. In an embodiment, for one entry fee, each customer 204 has a chance to win a jackpot. In addition to the excitement of the tournaments, the chance of winning the tournament jackpot is many times greater than winning a typical prior art lottery jackpot, thereby maintaining the audience's attention span. Preferably, any fixed odds table games, as known in art, is applicable to the teachings herein.

An interactive, customizable experience for gaming and other entertainment experiences is provided herein. Although many of the examples and features described herein refer to gaming with respect to casino 108, it is envisioned herein that users securely interact in many ways and in multitudes of applications in accordance with the teachings herein.

In accordance with on aspect, a live, broadcast is provided that includes casino table gaming experience 206, and preferably directly from a casino 108. Moreover, the broadcast is preferably available to customers, such as via a cable television 102 or other secured media delivery system, and at least partially provided on a channel for a fee. Customers 204 may be situated at home, in a hotel, a bar, or virtually anywhere. In one embodiment, customers 204 can view and partially interact with the channel for a limited access to certain “public” areas of the channel, and pay a fee for admission to “private” areas of the channel. For example, a public area of the channel may allow customers 204 to watch a casino game 206 played, while a private area allows customers 204 to actually play the game.

Preferably, the broadcast provides a product that combines a casino attendee's experience with interactive programming to simulate for the customer 204 a night out at a casino 108. The excitement and speed of a casino 108 experience is preferably captured for the home customer 204 in a way that no virtual internet or other known at-home gaming effort provides. In one aspect, the user has options to play a game 206 at home or to customize their experience by selecting, for example, game play, tutorials, hosted shows 208, group events, and other live entertainment. Preferably, the view and arrangement of the screens are also customizable, such that live shows, game play or the like are overlaid on the user's display with another television broadcast show. Also, and as described in greater detail below, a hardware and software architecture is implemented that enables fast, secure and convenient remote access to casino 108. In addition to supporting secure and convenient interactive gaming, the hardware and software architecture described herein supports many other applications, including financial transactions and casting ballots in an election.

The hardware and software architecture described herein is capable of supporting a significant market. In accordance with remote gaming, at least three demographic markets are targeted: casino attendees, internet gamers, and entertainment seekers. Casino attendees represent people who attend gaming establishments, such as casinos, and also seek a live entertainment aspect of a gaming establishment, such as casino 108, although unable to physically attend. While casino attendees may already frequent gaming establishments, they also seek a social and tactile experience when unable to attend. Internet gamers represent a group of current people who enjoy a gaming experience at home or another remote location. Internet gamers may prefer remote access for various reasons, including for reasons related to privacy, intimidation, distance, and practice. Internet gamers are preferably already experienced in gambling activities, and prefer a private and self-paced experience that is provided by a virtual and on-line experience. Entertainment seekers represent a group of people who may not be regularly or actively involved in gambling activities, yet already enjoy and seek a social, exciting, and personal aspects, such as provided by the systems and methods described herein.

The hardware and software architecture provided herein is designed to protect against and/or to address distributed denial of service (“DDoS”) attacks, blackmail, identity fraud, age verification and money laundering. Moreover, responsible advertising, age verification standards and player protection measures are concerns that are addressed by the technological advancements provided herein. By replicating the casino environment and merging it securely and safely in an interactive community, such as a social network, a new dimension is injected into known remote gaming systems.

In an embodiment, an accurate and stimulating representation of a true casino 108 experience is brought to consumers by offering entertainment, live gaming, hosted shows 208, and a wide range of help and customizable options. In addition, a combination of online activities, such as chatting and virtual rooms, is preferably provided. Preferably, a total casino 108 experience is provided as a comprehensive television show that includes many if not all of the attributes and stimuli of a physical casino 108 entertainment experience. Thus, the games 206, the provocative atmosphere and the sociable environment that contribute to making a visit to a casino 108 an attractive experience is emulated on television 102 and/or other media. In an embodiment, a plurality of different games 206 is broadcast simultaneously. For example, roulette is provided to enable a customer 204 to play along with a live game broadcast from a well-known casino 108. As the roulette game 206 is taking place, remote customers 204 place bets on the outcome, as though the customers are physically present in the casino 108. Moreover, tournaments with large jackpots, progressive pools, random prizes, team play, chatting or the like is simultaneously provided. It is envisioned herein that some individuals, for example of a particular demographic, will prefer to participate in large, jackpot tournaments. Alternatively, other individuals, for example, of a different demographic will prefer to utilize the interactivity provided herein. Moreover, people who seek more action may enter a progressive pool and create their own private betting rooms and teams.

In an embodiment, players can opt to play in regularly scheduled tournaments that begin, for example, every half-hour. In this embodiment, the jackpot of each tournament increases as more players participate, thus an increase in the number of entrants increases the jackpot. Preferably, multiple tournaments enable millions of users to compete for significantly greater rewards than available in known brick and mortar gaming establishments, or even via remote internet gaming sites. Moreover, team playing is provided as a function of the social atmosphere defined herein. For example, friends can define and create their own private betting rooms.

In an embodiment, a virtual table is depicted on the television 102 screen, such as in a picture-in-picture (PIP) format. Each player preferably assigns a customizable avatar, for example, a virtual character that depicts emotions, to his/her table, and receives a uniquely colored set of chips. Each player participating in the private betting room can see the other avatars at the virtual table. Players then chat with each other using remote control devices, keyboards, or other input devices. Players may even speak to each other via a voice chat function, for example, using headsets. Moreover, a team may compete against other teams one-on-one or in tournament format, wherein the accumulated win of an entire table is calculated and compared with other teams' scores. Preferably, teams are charged a fee to enter a tournament. In one embodiment, multiple fee entry levels are defined for access to respective tournaments. Prizes may vary, including money or a trip for one or more persons to a choice destination.

In operation, while a first customer 204 is playing in a private betting room, a second customer 204 friend may select the first customer's avatar and be brought to the first customer's 204 data profile page. The second customer 204 thereby gains an understanding of the first customer 204, thereby contributing to a society. Moreover, many aspects of an online community are replicated, such as blogging, vlogging, chatting, profiling, or the like. In this way, a community is provided via a television network and not on the internet. The content may be shaped by each network, and, preferably, customers 204 will not use the networks as portals to the internet. Rather, each network maintains its own community. Moreover, customer 204 profiles may be shared between networks. In another embodiment, a custom control center provided, for example, by media asset management server 110 and/or communications room 214, allows customers 204 to act as television show directors.

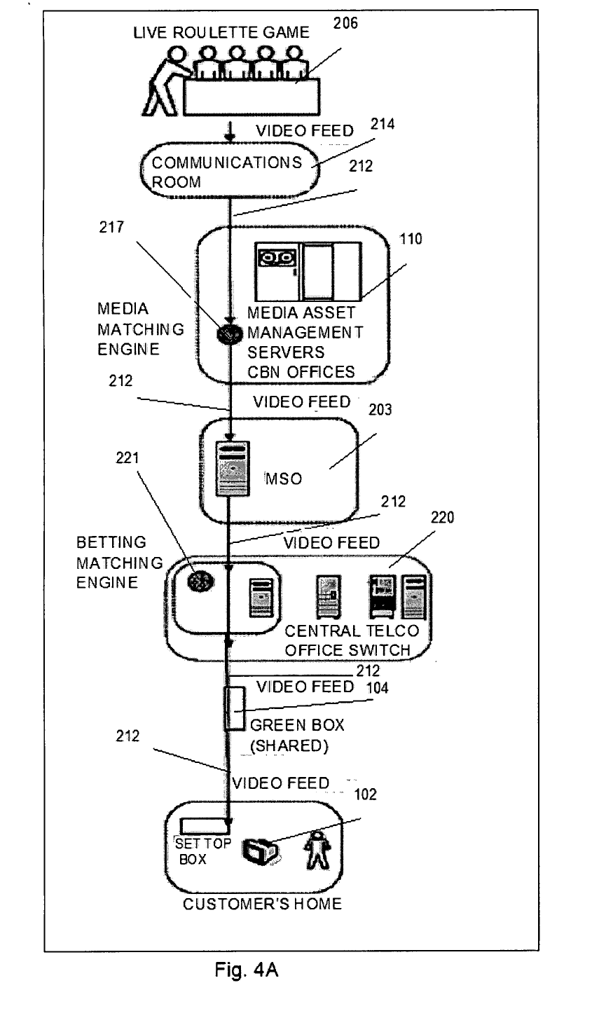

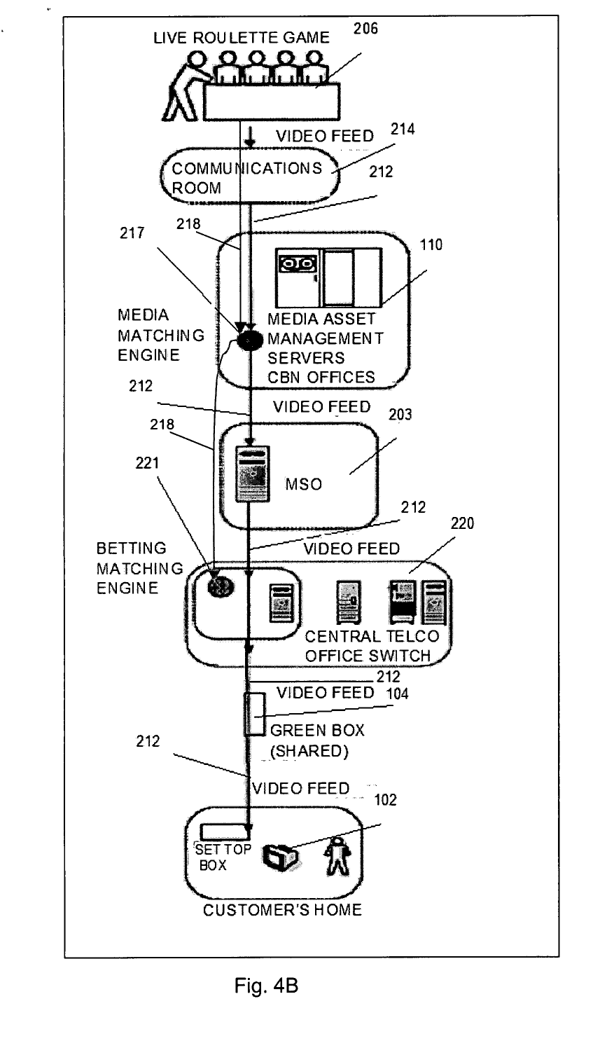

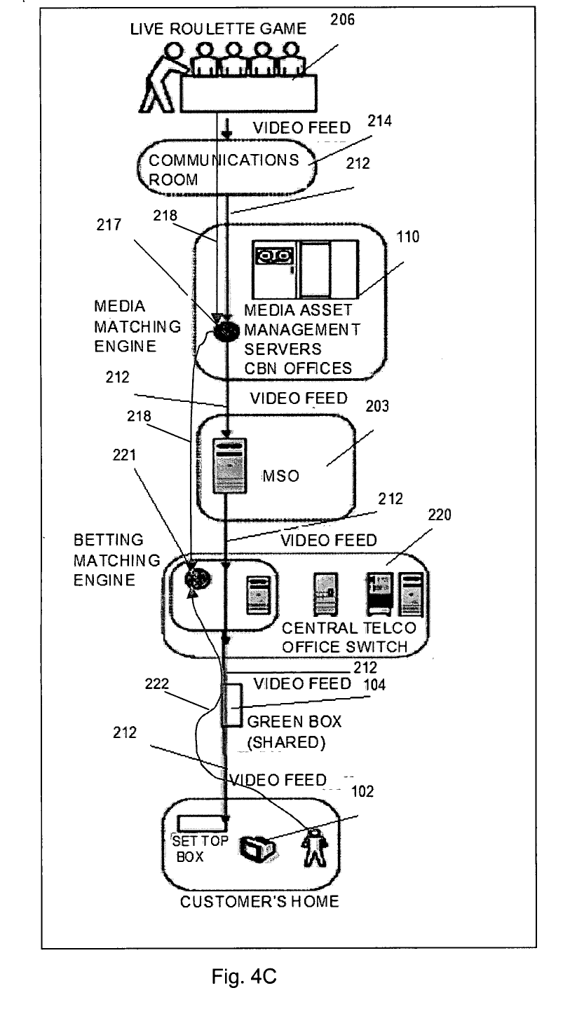

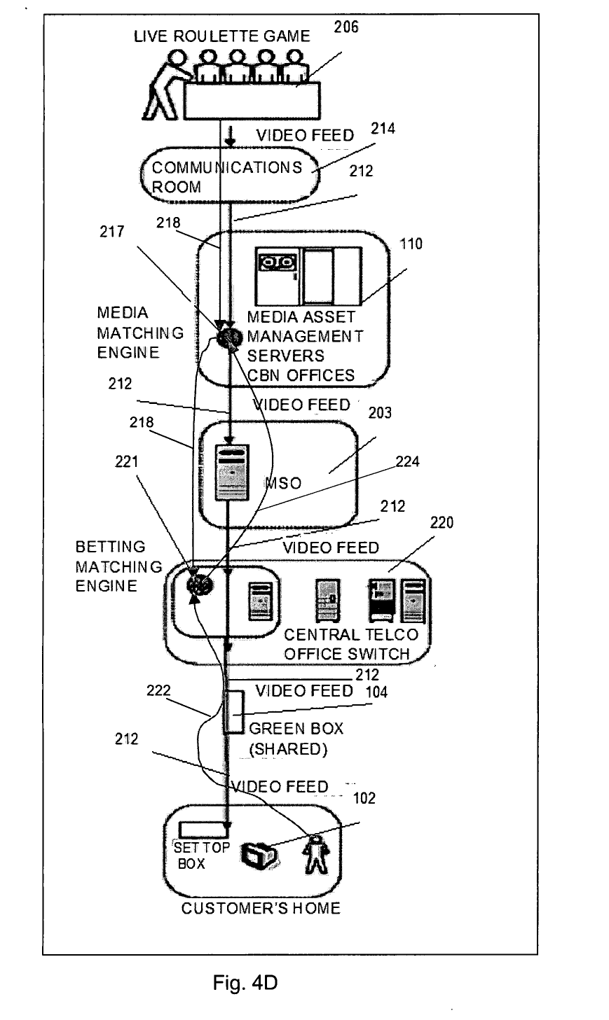

FIGS. 4A-4D illustrate an example embodiment in which data travels to and from parties associated with an embodiment. In the example shown in FIGS. 4A-4D, live gaming 206 occurs in casino 108. As described herein, other content may occur in lieu of or in addition to live gaming 206. For example, commentary, celebrity spotlights, audience participation, other non-gambling games, and voting may occur. The content, such as live gaming action 206 or other entertainment show is preferably filmed and transmitted to communications room 214, on site and at casino 108. Thereafter, video feed 212 is preferably passed through media asset management server 110 for viewing. Moreover, a digital copy of video feed 212 is preferably generated and saved with video metadata 218 is attached via video matching engine 217. Video feed 212 is preferably transmitted to multiple systems operator 203 for broadcast, for example, via interactive cable television in a dedicated cable television station. Moreover, video feed 212 is preferably forwarded to municipalities via multiple system operator 203. The customer from home and is able to play along with live casino games with real or “play” dollars. All this will be provided via a uniquely secure method that guarantees the time, place, intent, and identity of the customer. The customer 204 is able to interact, for example, by voting and participating. They will be able to win a chance to play with celebrities and earn money. Customers 204 further securely purchase items from advertisers.

Preferably, content is provided, such as a show being provided from a casino 108 that is broadcast to customers. The show may include, for example, live game 206 play, commentary, celebrity spotlights, audience participation, games and/or voting. The show is preferably produced on site at the casino 108 or other location, and is delivered (e.g., broadcast or otherwise transmitted) from the communications room 214 to media asset management servers 110 within shared services 202. The show is preferably delivered to a cable provider, and then broadcast on interactive cable as a cable station. The cable feed is preferably brought to municipalities from a multiple system operator 203 (e.g., an operator of multiple cable television channels) to cable television local central offices. In accordance with an embodiment that employs cable television, dedicated wires from the central office (“CO”) 106 are provisioned to respective neighborhoods' green boxes 104 that receive video feed 212 from a local central office for distribution to respective cable subscribers within the neighborhood.

Continuing with the embodiment shown in FIG. 4A-4D, customers 204 view the cable station broadcasting the show and are able to play along with live casino games 206 with real or, alternatively, “play” money. As noted above, the transactions are securely made such that privacy the customers' time of event, place, intents and identity are confirmed. Customers 204 are able to interact by voting and participating. Other features, such as described above, enable customers 204 to win prizes and various opportunities, and to securely purchase items from advertisers.

As shown in FIG. 4A, live game action 206 or other entertainment is broadcast via video feed 212 to a user. Video metadata 218 is attached to the digital video 212. Video metadata 218 preferably tracks pertinent information, such as time, place, location, results and changes.

As shown in FIG. 4B, video metadata 218 is separately transmitted to data matching engine 221 from video feed 212. As shown in FIG. 4C, users metadata 222 transmitted sent to the data matching engine 221.

FIG. 4D illustrates that video metadata 218 and user metadata 222 is matched, effectively completing a wager. Offsite to the user but in the same legal jurisdiction. The matched metadata is sent back to the media asset management server 110, for example, to be connected to the video feed 212 and saved using signature technology to establish time and synchronization.

A discussion identifying comparisons between physical, prior art casinos to the virtual gaming environment provided herein is now described below.

Physical casinos offer games that are, typically, physical in nature and are governed by normal probability. This leads to a visceral attachment to a game. When a player plays a table game, for example, the psychology of the player is noted, and the player has a sense of influencing the results and, therefore, may act in opposition to probable outcomes. In accordance with the teachings herein, a television 102 or other broadcast of a live casino table game also enables a player to have a visceral attachment to the game. The gaming experience is provided such that the customer 204 has a much stronger psychologically motivated sense of control of the game than provided in known computer generated or internet games. Prior art internet games do not produce this effect because they operate via a random number generator, and players do not have a sense of good will influencing the game.

Further, a live casino 108 atmosphere is unique and is provocative and rich. For example, table games are enhanced with a world of design and marketing techniques. The goal of these techniques is to fill a customer's senses and create an altered emotional and/or psychological state for the customer. For example, interpersonal contact is provided with alluring wait staff and other customers, and alcohol is typically dispensed, often free of charge. Moreover, sounds of slot machines and excited players also contribute to an energetic environment, which increases the likelihood that customers 204 will lose good judgment. Typically, these stimuli are provided by the casino 108, itself. The design of the casino 108 has a particular goal: to make people gamble more, and this confusing atmosphere leads or otherwise encourages players to take higher risks.

In addition, customers 204 may even add their own music by choosing a music stream provided by multiple system operator 203, or by connecting their personal music device to their set top box, thus providing a truly custom experience.

In accordance with a preferred embodiment, the television 102 atmosphere is also filled with provocative visuals i.e. sexy customers, shills, provocative commentators and celebrity hosts. The stimulus existing in a casino 108 is preferably exploited and enhanced for the customer 204. For example, after hours customers 204 may enjoy watching adult-oriented content and gaming. The sounds of the casino 108 are recorded live via microphones that are strategically placed throughout the areas surrounding the table game 206. Moreover, video environment is provided in high definition quality and in a sports-like production. Preferably, the video and audio elements of the broadcast are customizable. Customers 204 control volume of commentators, background casino 108 noise, croupier and/or the players at the table. Customers 204 also control camera views, including the zoom factor. Thus, the broadcast representation of the live casino 108 atmosphere is also provocative and rich.

Inside a physical casino 108, customers 204 are often anonymous, and casinos typically capitalize on this aspect. Recently, the Las Vegas Visitors Authority ran a television advertisement depicting two women who pretended to be different people to each man they met. Anonymity allows for fantasy role playing. An average person can pretend to be a high roller, a humble, wealthy business person, or whatever his/her imagination creates.

In accordance with a preferred embodiment, users who so desire are also similarly portrayed anonymously. When a customer 204 access the systems and methods described herein, for example, the customer 204 creates his/her own respective profile and/or a three-dimensional appearing avatar, which depicts the customer 204 at a private betting tables. Hundreds of customizable character profiles are provided for a customer 204 to select. Even the avatars' reactions and personalities are customizable. Thus anonymity and role playing is supported herein.

Also, inside a physical casino 108, people may talk to other customers 204 and the interaction has unlimited potential. A known limitation is the number of people that can interact in the space surrounding a single table. In accordance with the teachings herein, when a customer 204 is ready for play, he or she joins one of the many private betting tables that are available for selection. As used herein, a betting room represents, generally, a small group of players who are situated together at a virtual table. The virtual table is preferably depicted on a customer's television 102 screen, for example in a picture-in-picture format. A physical or live casino table game 206 determines the outcome of each game, and a group of players share the excitement with the virtual players. Players see their friends' bets, and are able to interact with them, all within the comfort of their homes. Players may be friends, or may step up to a table of strangers, exactly like in a physical casino 108. In this way, an at-home game is provided as a social event, just as in a physical casino 108.

Moreover, in an embodiment registered members and/or the proprietor of the teachings herein, create visual and other display themes for a custom and communal effect. Players' control of community content ensures that they take ownership of it, thus expanding its reach. Moreover, profile creation, chatting, speaking with and viewing other players are all functions of the community experience provided herein. Thus, an entire social environment is created. Moreover and in an embodiment, VIP betting rooms, where successful players are invited to join, are created, such as a “Winner's Circle,” where top players gamble and interact.

In a physical casino 108, customers 204 are instantly rewarded. In accordance with the teachings herein, customers 204 also win or lose in live time. Additionally, customers 204 receive complementary (“comp”) points instantly. The values of comps are preferably displayed on customers' display screens, for example, on demand or continuously. In this way, comp value increases are immediately displayed to customers. In a preferred embodiment, comps may be used to purchase items from participating partners/sponsors.

In another embodiment, an instant prize program is supported that regularly (e.g., hourly or half-hourly) offers a random player a sponsor-supplied prize such as a car or Las Vegas vacation. Alternatively, instant prizes are preferably awarded several times during a show. Prizes are preferably given to users who are currently participating in a game, and are preferably provided by sponsors.

In a physical casino 108, various peripheral (e.g., non-gaming) activities occur. Thus, customers 204 inside a physical casino 108 know that casinos offer more activities beyond gambling. For example, physical casinos include restaurants, world-class boutiques, and entertainment shows and nightclubs.

In accordance with the teachings herein, virtual peripheral activities on are also provided. Customers 204 can order a Las Vegas show on demand, can enjoy shopping on demand and links to entertainment venues.

Moreover, in a physical casino 108, table games 206 are limited to the tables' physical sizes, and may only allow ten or so customers 204 to play at one time. A limitation of physical casinos is that there is no chance to offer tournaments and large jackpots. In accordance with the teachings herein, one virtual table game may support millions of people to play simultaneously, thus offering tournaments with huge jackpots. These tournaments are believed to be appealing to the masses, and are used to promote various other offerings, described herein.

Moreover, physical casinos offer customers 204 a chance to win a progressive prize on some slot machines and some table games 206. Progressive slots may be linked between casinos to increase prizes. In accordance with the teachings herein, progressive games are also provided and an opportunity to play for a progressive jackpot during each spin of the roulette wheel, throw of the dice, or hand of Baccarat is further provided. This extra level of gaming excitement enhances the viewing experience.

In addition to emulating experiences and benefits of physical casinos 108, features are provided herein that extend beyond physical casinos. Unlike physical casinos, for example, croupier personalities will provide entertainment for customers 204 and will be entertaining. In a physical casino 108, individual croupier positions change regularly, and for this reason, croupiers do not lend themselves as a major selling point in a physical casino 108.

Furthermore, the ability to play for fun inside a casino 108 is typically not available, as customers 204 are required in physical casinos to engage in active and actual wagering. Unlike physical casinos, playing for fun is supported herein and is believed to be a convenient way for an average person to become a customer 204. A customer 204 becomes confident with the decision to gamble. In one embodiment, recorded lessons from a live dealer for all of the major games 206 being offered are provided for customers.

Thus, favorable attributes of physical casinos 108 are emulated herein, and additional benefits and features not currently available in physical casinos are further provided. For example, live game activity, carefully crafted atmosphere, fantasy role playing, socializing, instant gratification, peripheral activity, liquidity, and progressive prize pools are supported herein. Plus, features that brick and mortar casinos do not offer, such as play-for-fun games, and low table minimums, are further supported. Preferably, customers 204 are provided with their respective and customizable profile pages, similar to internet profile pages, but are not accessible via the internet, but only by other members. This feature enhances the development of a community.

In an embodiment, a realistic gaming experience is provided via television or other remote media channel for a user. Preferably, a television game channel is provided to customers 204 for fee. The channel may be a complete cable channel, a sub-channel offering on an existing channel, or an add-in feature, which is implemented on any existing channel. For example, a portion of a user's display screen may be used for wagering, while a game show channel is provided in the remaining portion. In this way, an assortment of casino-related and non-casino-related elements is provided in one offering.

Preferably, a television gaming/gambling channel provides safe, real-time, casino gaming as a function of interactive cable television services. Preferably, live casino table game action is provided from one or more known, named Las Vegas casinos that far exceeds typical prior art virtual internet gambling.

In one embodiment, customers 204 make selections to define groups of players that customers 204 compete against. A single group may include people who are in the same geographic location as well as other customers 204 in remote locations. Thus, new communities are supported for collaborative game play. Further, it has been determined that socially networked offerings provided over interactive cable television services are highly successful. Accordingly, the television gaming/gambling channel platform provides for enhanced interactive solutions.

Preferably an interactive and digital cable television environment is provided. One skilled in the art will recognize that alternative embodiments, such as non-digital cable television, satellite television service, and broadband services may be applicable in accordance with the teachings herein.

Moreover, use of a television set that is operable to receive and display cable television transmissions is employed. Alternatively, one skilled in the art will recognize that other receiving devices, including personal computers, personal digital assistants, cellular telephones or the like, may be connected to and/or receive transmissions from a cable (or other) television service provider. Further, various kinds of television 102 sets known in the art are envisioned herein, such as cathode ray tube (“CRT”) televisions 102, projection televisions 102, plasma screen televisions 102 and liquid crystal display (“LCD”) televisions 102.

In a preferred embodiment, continuous broadcast of live casino games 206 that are in progress, for example, from Las Vegas or other legalized gambling location. The broadcast is preferably not limited to table game action 206, but is preferably balanced and controlled with other forms of entertainment. For example, members of a casino 108 establishment may be broadcast, such as the croupier, pit boss and cocktail waitress may be provided who are actually cast members adding lib and jokes.

A customer 204 preferably begins a session by tuning to the gambling network channel provided a proprietor hereof, and the customer 204 proves his identity, for example, via a fingerprint authentication provided to the customer 204 and described above with regard to the middleware application.

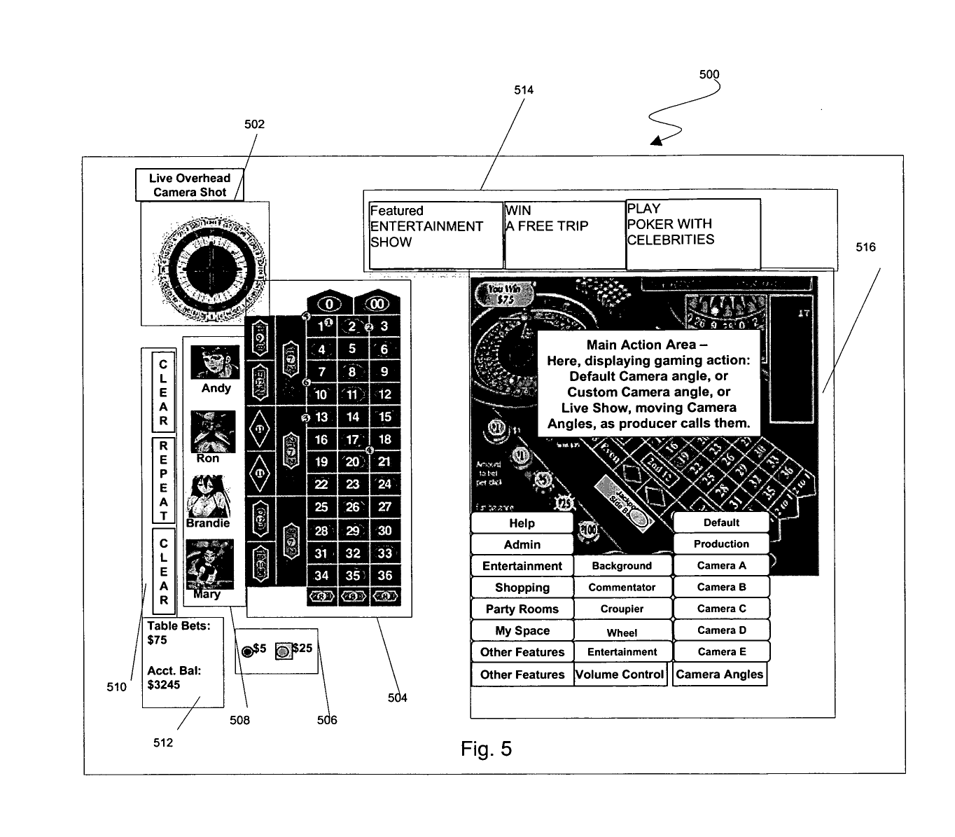

FIG. 5 illustrates an example display screen 500 provided on a customer's 204 television 102. The example screen display 500 represents an embodiment in which customer 204 is participating in the game of roulette. Of course, one skilled in the art will recognize that many variations of example display screen 500 are envisioned herein, and that many various games or features may be displayed therein.

As shown in FIG. 5, roulette wheel 502 is illustrated for customer 204 to monitor the live gaming 206. Moreover, roulette table 504 is further displayed for customer 204 to select a respective wager. Wager value 506 is provided for customer 204 to select an amount. In the example shown in FIG. 5, a $25 wager is selected.

Continuing with reference to FIG. 5, customers avatar display section 508 displays other customers 204 who are participating with the customer 204 at the respective roulette table illustrated in FIG. 5. Also shown at wager action section 510, a customer can select whether to clear or repeat a respective wager. Wager monitoring section 512 provides an indication to customer 204 the current table bets and the account balance for customer 204.

At options section 514, customer 204 is presented with selections for viewing an entertainment show 208. Customer 204 is further provided with options for winning a free trip, and playing a game of poker with celebrity legends.

Main action area 516 provides customer 204 with many options for a customized gaming experience. Included in area 516 is another view of roulette table 504, and various graphical screen controls, such as window buttons, are selectable for customer 204 to change a respective camera angle. In the example shown in display screen 500, the user can select a default view, a production view, or select from cameras A-E. Moreover, a customizable camera angle is selectable for customer 204. Other selectable options available to customer 204 in main action area 516 include help, which preferably invokes customer service/pit boss 226, administrative entertainment, shopping, party rooms, personal profile and/or social networking options.

Thus, as illustrated in the example display shown in FIG. 5, a customer 204 is afforded significant control over the way gaming is displayed, and many selections are provided for customer 204 interactions.

Preferably, a virtual play board (e.g., a game table) is projected at the customer's 204 location, such as on a flat surface and within the reach of the customer, which is used by the Customer to interact with the system and play a respective game. By using a projected virtual play board, the customer's 204 experience is substantially enhanced as he physically participates using a familiar and convenient representation of a game table or play board.

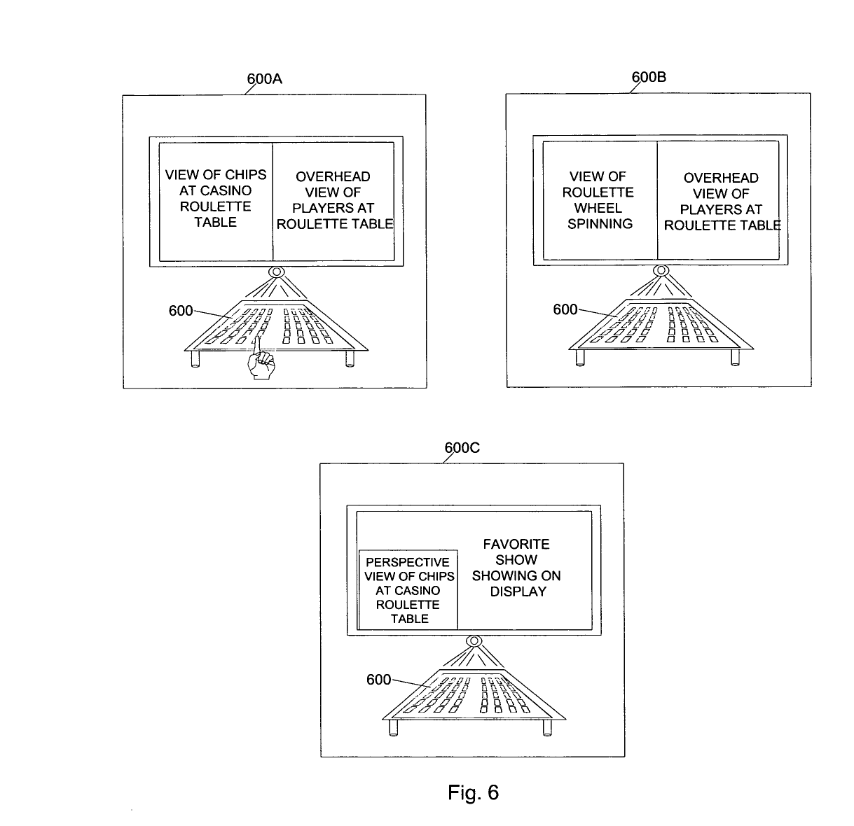

FIG. 6 illustrates example displays 600A-600C that each includes virtual playboard 600, and that is operable for customer 204 to make game and screen selections. As shown in display 600A, customer 204 merely taps on images of chips on virtual playboard 600 to select a monetary denomination, and then taps on the spots where customer 204 would like to place bets. Once all the bets are placed and confirmed the LIVE WHEEL spins in a physical casino 108 (display 600B). Further, as shown in display 600C, customers' 204 traditional television and other forms of entertainment are preferably provided with or, optionally, without live gaming activity 206. In this way, once customers 204 have configured their game play to their liking, they can then minimize their game and watch their favorite show.

In one embodiment, the customer's television 102 screen display is divided (or split) into two or more sections to feature various elements. For example, one portion of the television 102 screen displays video of a live table game 206 at a casino 108 location, and another portion of the television 102 screen displays the virtual table representing the customer's 204 virtual game board. Of course, other embodiments are envisioned herein, such as several sections of the television 102 screen depicting various remote customers 204, each possibly depicted by a personal avatar.

During play, wagers are preferably placed and displayed on the customer's 204 virtual table, and the bets placed on the virtual table are preferably simultaneously depicted on the television 102 screen. Once bets are placed, the customer 204 preferably verifies his bets, for example, by making selections of graphical controls. For example and in the case of roulette, after a bet is placed the customer 204 watches as an actual wheel is spun at a casino 108 location and the results are displayed on the customer's television 102. Further, the customer's screen preferably confirms whether he has won or lost, and appropriate financial adjustments are made. Thereafter, the customer is ready for the next wager.

Preferably, hardware, such as a set top box distributed to customers 204, is provided for operation. In a preferred embodiment, the existing cable set top box is OCAP compliant, and the virtual playboard projector plugs into a customer's 204 set top box. Preferably, the device is not a special set top box, but is a newer interactive box. Preferably, once connected a cable subscriber in the one location can begin gaming immediately by using a remote control, which came with their set top box. For example, the set top box operates to provide the virtual game board and/or fingerprint authentication, as described above.

In one embodiment, a small-sized projector attaches to the set top box and beams an image of a game board, such as a roulette table onto a customer's 204 physical table or other surface. The customer 204 merely taps images of chips to select a denomination and then taps on the spot where he would like to place the bet. As noted above, the television 102 screen preferably shows the customer's 204 bet on the table and asks him to verify the bet.

In one embodiment, a game show, for example, called “The Vegas Spin,” will be provided to attract customers, and to walk customers 204 through various processes associated herewith. For example, customers 204 are assisted with opening a new financial account, educating customers 204 how to use the technology, and how to play the respective games that are displayed.

The product includes an interactive service combined with real television 102 entertainment. In the prior art, a gaming channel cannot provide real time play, realistic interaction, and a level of security and regulation that would be able to attract true Las Vegas Casinos.

In accordance with the teachings herein, a new level of security and compliance to entice well-known casinos to join forces with. New levels of response time and usability are provided for users to have a complete experience of casino table games 206, right in the comfort of their homes. Customers 204 play along with live events and use real-time, interactive virtual tables that are used to play locally and remotely with friends. Moreover, a level of security and compliance to any cable solution is supported to ensure verifying an identity of a person, as well as the age of the person, the location of the person, and the time of any given event or request. Further, a person's intent is validated, by synchronizing and auditing what the person saw and/or heard at the time the person acted on that intent.

Also, a virtual playboard is provided that projects a game table, and accompanying software is provided that displays a customer's 204 playboard selections on the television 102 screen.

The middleware technology allows for jurisdictional purchasing that currently is not permitted on the internet. For example, liquor purchases on the internet are highly regulated and limited because of the internet's inability to provide validation of state taxation and transport laws. Thus, a way for highly regulated purchases to occur from the home is supported, which is not available over the internet in the prior art.

Further, since the middleware application does not transmit the digital video content, no video compression is required to take place. This is a significant feature because often video that has been compressed is questionable to used as evidence in court.

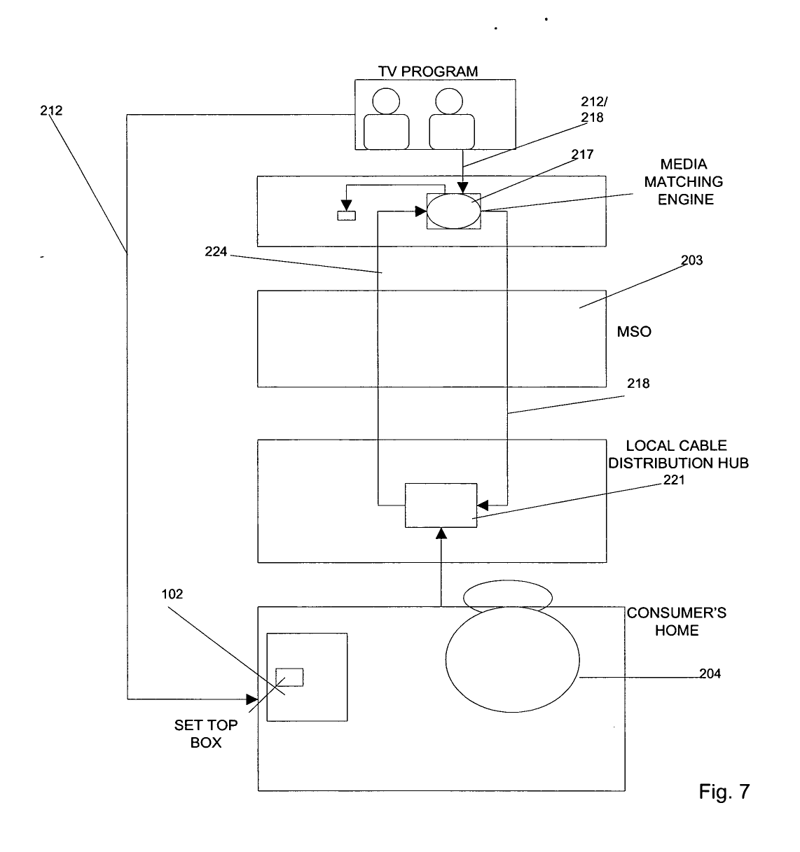

FIG. 7 illustrates an alternative example arrangement including an example flow of information and order of operation in accordance with an alternative embodiment. As shown in FIG. 7, a television program or other video feed 212 is telecast to a user 204 at the user's home. Video feed 212 and video metadata 218 are sent to media matching engine 217, and sequenced together. The sequenced video metadata 218 without video feed 212 is preferably transmitted data matching engine 221, and preferably located at a secure location close to the user 204. While user 204 watches video feed 212, user 204 decides to make a purchase. A request for purchase/transaction is sent to data matching engine 221. The transaction is preferably validated by matching the user's 204 request with video metadata 218, thereby providing matched metadata 224. The matched metadata 224 is transmitted to the media matching engine 217, for example, to process a financial transaction and fulfillment. The completed transaction is preferably stored in media asset management server 110, for example, for auditing and customer service.

Preferably, the application is provided that, in one or more embodiments, uses at least a non-proprietary set top box, data matching engine, and video matching engine which integrally plug into and comply with existing technology including, for example, OpenCable Applications Platform (“OCAP”) programming and Data Over Cable Service Interface Specification (“DOCSIS”) protocol.

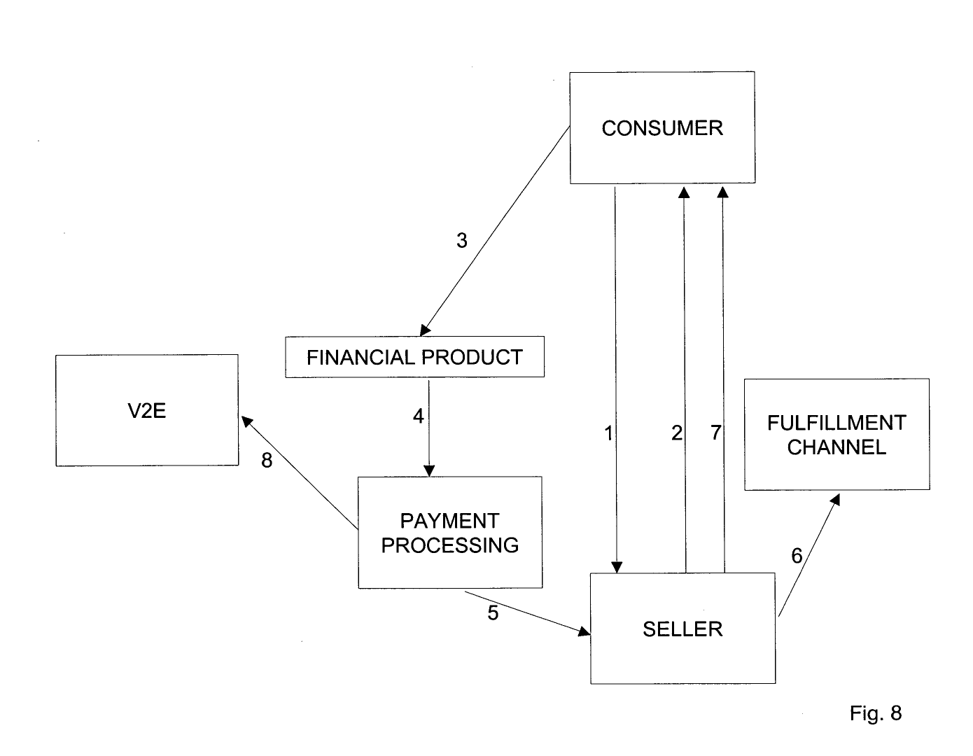

FIG. 8 illustrates yet another alternative embodiment of an example arrangement and flow of information in accordance with the teachings herein. At step 1, a consumer (user 204) decides to make a purchase. Thereafter, at step 2, a data transport begins, wherein the seller offers data transfer via the teachings herein or, alternatively, the user 204 selects data transfer via the teachings herein. Thereafter, at step 3, user 204 executes a payment method and a financial product is executed. A payment request is sent at step 4 to a payment processing center, and, at step 5, the financial transaction is validated, the user's 204 account is credited or debited, and a verification of the transaction is transmitted to the seller. The seller maintains an active communication session with, for example, media asset management server 110.

Continuing with reference to FIG. 8, at step 6, the seller begins a fulfillment process and, via a TCP/IP or other internet session, sends the user 204 a receipt of payment and acknowledgement of a completed transaction (step 7) Thereafter, at step 8, the payment processing center credits an account for the transaction.

Using the features shown in FIG. 8, consumers are protected against theft of information, or unauthorized use of their financial product, because the execution of the transaction is verified as genuine by the consumer's consent, the seller's consent, location verification, and by time stamping.

One skilled in the art will appreciate that the broadcast channel or middleware applications, described above, provide an added value to an existing television 102 or other entertainment show that can be delivered as a full cable channel, a sub-channel on interactive Cable, or as an add-in to an existing channel, or even a single show.

Furthermore, a virtual game board 600 or other interface that is projected on a flat or other surface is preferably provided to enable a customer 204 to make selections that are to be transmitted and received by one or more parties, as described herein.

In accordance with an embodiment, security and personal identities for transactions are ensured as part of a new protocol for a cable environment. The new protocol preferably utilizes the physical characteristics of devices provided in the “last mile,” as known in the art, to guarantee an audit of a location, time, and person. Preferably, one or more signatures are applied to transactions that are directly linked to properties regarding how a particular location is tied into a cable infrastructure. The signature encapsulates the identities of several physical objects or devices, each having a respective hardware signature. The combinatorics related to this type of security exceeds the value of two to the power of 32 (i.e., 232). This is many magnitudes better than the known PGP encryption or, alternatively, 64 bit md5-hash encryption, of PKI (Public Key Infrastructure) technologies.

Also, in an embodiment, time stamping on the transactions are “nested” in such a way that there is a stamp representing an actual time of an event and a stamp for an actual time that the event was viewed at a location. Accordingly, all transactions are bounded above and below by these stamps. This enables one to prove that customers 204 are not able, for example, to place a bet in advance of an event or to or collaborate in order to ensure a desired outcome.

Moreover, demographic data collected by the customer, location, and time verification system described herein is operable to produce several revenue streams in the worlds of marketing and advertising. For example, targeted marketing campaigns can turn into a very large income source. Likewise, the ability to offer reward points via usage and interests is a business method that is envisioned herein, similar to those implemented by UNITED AIRLINES REWARDS ($35 m) and MYPOINTS ($170 m), for example.

Accordingly, the technology combined with this marketing data results in a new offering for advertisers. Advertisers can target homes, for example, by age and interests for particular products. As an example, FORD MOTORS buys an advertising spot and then transmits different commercials to different respective households. For example, luxury car advertisements are transmitted to higher income demographics. Sports cars advertisements are transmitted to extreme fans, and reliable used car advertisements are transmitted to homes with teenagers. Thus, using the data obtained by the system and method described herein can be used for targeted advertising in countless ways and contexts.

Thus, a new technology integrator is provided for a unique and truly secure validation process that protects the electronic transfer of digital assets and financial data. As e-commerce is expanding exponentially, solutions are provided herein to the frailties of existing transactional security measures, which have become apparent and costly. Particularly, a proprietary data transport system that secures transactions within existing distributed communications systems, such as cable television 102, satellite television, and mobile telephone technologies, is provided. A significant impact is provided by utilizing bridging vital internet transactions over distributed systems that have been secured in accordance with the teachings herein. This feature, referred to herein, generally, as a “bridge-to-internet” solution, enhances known internet technology and provides the security of a “hard wired” system for those transactions that need to be protected beyond what the internet currently can ensure. Protection from theft of data and money by moving secured transactions to a system where those problems do not exist is provided. This is a first for the internet and it answers issues of security, fraud, and user confidence beyond any existing security solution.

Most thefts and hacks on the internet occur from malicious people and software attempting to impersonate an element of the communication path, such as the user, a router, a server, or a web site. Such impersonations are not possible in accordance with the teachings herein. Instead, a consumer enjoys the freedom and expanse of choices previously expected from the internet. Once a consumer decides to make a purchase or exchange critical data, his/her private information is conveyed not via the internet, but via the systems and methods shown and described herein. Unlike prior art systems, private data are not transported exclusively over the internet.

Additionally, vendors and companies providing services on the internet can guarantee a new level of protection because the servers and systems that contain customer information will no longer be accessed through the public internet. Costly breaches of security on the internet that typically originate from people accessing servers that contain financial information for thousands of users are now prevented.

The systems and methods herein do not replace existing known internet security measures, such as firewalls, key encryption, secured sockets layer, and PGP, but rather enhances and compliments these existing solutions at a more physical level. Users, vendors, and merchanting agents will all benefit from the systems and methods described herein. A technology enhancement is supported that is built on existing infrastructures, and hence, its speed of deployment, and growth are determined by the services already in use.

Moreover, multiple revenue streams are generated by the systems and methods herein. The first is through licensing middleware providing business-to-consumer (B2C) security, which historically compared to other middleware solutions, generates billion dollar plus license fees. The second revenue stream is a business-to-business (B2B) per transaction fee from vendors benefiting from loss prevention. Plus new revenue streams will open as the bridge-to-internet technology focuses on satellite and mobile device bridges to the internet, as well as unique interactive programming content. The intent is to launch the bridge-to-internet technology for U.S. Cable-based service providers. The U.S. market's deep cable penetration, digital fiber infrastructure, and general customer demographic are compatible with the systems and methods described herein, resulting in a lucrative partnership in technology development and deployment. Working together permits an optimized affordability, distribution, and value of Cable Television 102 empowered by systems and methods described herein.

The systems and methods disclosed herein preclude penetrations from security, privacy, and financial threats is provided herein. In e-commerce applications, critical data are out of harm's way. For example, international piracy, identify fraud, malicious code, corporate espionage and hacking are thwarted.

An example is now described with reference to the teachings herein. A program is telecast to a home. Metadata about the video is sent to a media matching engine 217. Video and metadata are sequenced together, and the sequenced metadata, without video, is sent to a Data Matching Engine at a secure location that is preferably close to the consumer. While watching the program video, the consumer decides to make a purchase. The consumer's request for purchase/transaction is sent to data matching engine 221. The matched transaction information is sent to the media asset management server 110 at a back office to process financial transaction and fulfillment. The completed transaction is stored for auditing and real-time customer service, and the transaction is validated by matching the consumer's request with data from the related video.

In another embodiment, a consumer decides to make a purchase of a good. Data transport preferably begins when the seller of the good or consumer purchasing the good selects the middleware and data protocol for the sale mechanism. The consumer utilizes the middleware and secure data protocol to execute his/her payment method, and the financial product is executed. Thereafter, the seller's computer, e.g., server computer, sends a handshake command (as known in the art) to determine that the user has interactive technology, such as interactive cable television, and, if so, ensures that the technology is compliant with the teachings herein. In case the connection is compliant, a checkout display screen is preferably sent to the user via the set top box. The checkout page is preferably generated video that corresponds to the user's responses, such as name, address, credit information or the like. When the checkout page is complete, a validation request is transmitted to the seller and, when validated, a receipt is preferably transmitted to the user and fulfillment of the purchase occurs. In this way, the consumer is protected against theft of information, or unauthorized use of his/her financial product, because the execution of the transaction is verified as genuine by the consumer's consent, the seller's consent, location verification, and by time stamping. Further, the consumer and seller are protected from internet fraud during the transaction because the transaction itself does not occur on the internet; it occurs on a more secure “hard wired” (e.g., cable system secured via the teachings herein) system. The consumer and seller are protected from corporate piracy at all points of data storage because those points can not be “seen” or accessed from the internet. In other words, servers at a vendor's site contain critical user data are off the internet, and on the cable system.

Moreover, existing security platforms benefit from the teachings herein. Rather than pose a competitive challenge to current and developing security and privacy platforms, known security measures are enhanced and enriched. The systems and methods herein work in conjunction with known platforms, such as DOCSIS®, to maintain integrity and make them more potent. This is vital since DOCSIS was primarily developed to protect against theft of cable service from piracy and descramblers, and since current security measures require separate installations at the application program level. The systems and methods described herein “sit below” the DOCSIS transport, and guarantee security and privacy by seamlessly verifying the person and his action against what he is viewing at the time of his actions. Then, actions are verified and transactions are completed from a secure non-public location. In accordance with the teachings herein, data transfer activities occur off of the public internet, thereby fortifying existing security systems.

Thus and as described herein, a new security protocol is defined that provides protection beyond that previously available, for example, over the internet. The new protocol is preferably integrated into a new combination of hardware and software that makes the platform capable of being customized and licensed for various industries and uses, beyond gaming. Moreover, a use of a matrix switch, which is capable of connecting a plurality of input to a plurality of outputs, and operable with the data matching engine 221 provides a convenient and cost-effective approach for distributing video across various platforms and over the “last mile.”

The systems and methods for transmitting and validating data ensures that the platform is provided having an architecture that inherently prohibits known methods of online security fraud, hacking, and identity theft. Further, there is tremendous potential to generate revenue from the licensing of the systems and methods described herein. Low break even points, low start up costs, low scalability cost of growth, low subscriber requirements for success, low requirements in staffing and fixed assets and no technological/hardware infrastructure obstacles to growth are all factored together that results in a profitable and lucrative business model.

Although the present invention has been described in relation to particular embodiments thereof, many other variations and modifications and other uses will become apparent to those skilled in the art. For example, using the secured protocol and middleware described herein, health insurance providers can offer in-home access to confidential and previously unavailable medical records. In a preferred embodiment, a health channel is provided that includes a patient and doctor side. Patients retrieve information, shop for doctors, even pay medical bills or contact insurance companies. Doctors post medical results, schedule meetings and collect revenues. Both patients and doctors preferably store, retrieve, and view critical record and film, and comply with various requirements, such as defined by the Health Insurance Portability and Accountability Act (“HIPAA”). Such compliance is provided because a person, the person's location, and permission to view an object securely are validated and ensured.

The systems and methods described herein provide an effective risk management tool to reduce costs, for example, due to lawsuit stemming from lost records. In one business method, the middleware and secure protocol can be provided for a low fee, such as one dollar a month added value for health insurance carriers to offer to their subscribers, potentially netting tens of millions of dollars in previously unrealized capital.

In another embodiment, the middleware and secure protocol described herein can function to securely transport files between imaging centers and physicians' offices. A typical physicians' office with four to six physicians may spend an average of $150 k per year on courier and transportation services. It is believed that those physicians would gladly pay more for a faster and safer delivery method. Moreover, many (if not most) physicians' offices would save an FTE (Full Time Equivalent person of 30 k year) when they employ electronic records handling in accordance with the teachings herein. A proprietor of the systems and methods herein that provides a secure transport of files between hospitals and physicians' offices may result in earnings of hundreds of millions of dollars.

Moreover, similar to insurance companies, physicians who use the systems and methods described herein can offer records access to all their patients. The middle and secure protocol that offers such record access service at, for example, $5,000 per year, per practice, may net hundreds of millions of dollars.

Another non-gaming application of the middleware platform and secure data protocol is for voting. Currently, many so-called “reality” television shows offer at home voting via the customers' cellular telephones.

In yet another application, the middleware and secure data protocol can be implemented for electronic bill payments. For example, the systems and methods described herein can be offered as a single source for all home maintenance bills such as oil, gas, electric, water, cable television 102, and/or telephone phone. This is believed to be an attractive alternative for many internet users who do not trust the internet for secure financial information. Such users would be more amenable to the secure platform provided herein, as well as the ease of use and overall convenience.

Accordingly, a middleware and corresponding data protocol that ensures secure, efficient and convenient operations for end-users, even for users who are not technically proficient, is provided. Moreover, a core technology is preferably provided that includes at least a matching engine that receives metadata representing a video feed, and metadata that represents a customer and the customer's actions, and matches the two sources of metadata. The two sources of data are preferably sequenced together for cross-referencing purposes. A physical topology or architecture is further disclosed that utilizes, in one embodiment, a cable television infrastructure that is supported by multiple system operators 203. Other embodiments include satellite television and cellular telephone technologies.

Further, a back-office technology is provided that includes a data storage element for storing digital video, video metadata, customer metadata and/or sequenced customer metadata with video metadata. The various data that are stored are preferably available 24-hours per day, seven days per week for access by a live help-desk or customer service operation. In this way, customer service is provided for customers that includes current and accurate data.

The features and advantages of the systems and methods provided herein are supported at least in part by a media matching engine, a data matching engine, an internet security bridge and a video validation protocol. Moreover, non-recursive, non-pattern generating signatures are provided, thereby precluding any party that attempts to eavesdrop or otherwise intercept transmissions set forth herein gains no meaningful access to information. Instead, data are preferably filtered such that only reference information is transmitted and that identifying data, such as names, addresses, bank accounts or other personally identifying information, which may be used by unscrupulous parties, are not transmitted.

It is preferred, therefore, that the present invention not be limited by the specific disclosure herein.

What is claimed is:

1. A method for validating a selection made by a user in connection with a remote application, the method comprising:
receiving a video feed from a video source, wherein the video feed includes at least one image;
receiving with the video feed corresponding video metadata, wherein the video metadata includes electronic information representing the at least one image in the video feed;
transmitting the video feed to the user via a broadcaster;
transmitting the video metadata to a data matching engine;
receiving from the user the selection, wherein the selection is responsive to the video feed;
receiving by the data matching engine user metadata that includes electronic information representing the selection; and
matching by the data matching engine the video metadata with the user metadata to provide matched metadata, wherein the user's selection is validated as a function of cross-referencing the matched metadata and the video feed.

2. The method of claim 1, wherein the broadcaster is a multiple system operator.

3. The method of claim 1, further comprising receiving the selection from the user as a function of a television set top box.

4. The method of claim 3, wherein the television set top box is OpenCable Applications Platform compliant and the selection is formatted to be data over Cable Service Interface Specification protocol compliant.

5. The method of claim 1, wherein the video metadata represents at least one of selected from the group consisting of transmission, location, croupier name, local time, relative time, pit boss name, table number, time of an event, outcome of an event and validation of the outcome of the event and corresponding to the at least one image.

6. The method of claim 1, wherein the user metadata represents an identification of the user, the location of the user and the time the selection is made.

7. The method of claim 6, wherein the at least one image represents live game action and the selection represents a wager placed by the user on the live game action.

8. The method of claim 7, wherein the user metadata further represents at least one selected from the group consisting of an amount of the wager, local time, relative time and time delay from video feed.

9. The method of claim 1, further comprising electronically receiving from the user personally identifiable information, wherein the personally identifiable information is received separately from the user metadata.

10. The method of claim 9, further comprising matching the user metadata with the personally identifiable information.

11. The method of claim 1, further comprising storing the matched metadata and the video feed in a database.

12. The method of claim 1, further comprising providing user help service as a function of the stored matched metadata and the stored video feed.

13. The method of claim 1, wherein the video feed includes an audio portion.

14. The method of claim 1, wherein the video feed is transmitted to the user via at least one selected from the group consisting of cable television communication, satellite communication, and mobile communication.

15. The method of claim 1, further comprising determining a location of the user.

16. The method of claim 1, wherein the selection from the user represents a vote or a wager.

17. The method of claim 1, further comprising transmitting by the broadcaster the video feed to a shared device, and distributing the video feed to the user and a plurality of other users from the shared device.

18. The method of claim 17, wherein the shared device is a central office.

19. A method for executing a wager in connection with a remote gaming application, the method comprising:
maintaining an electronic financial account for a user operable to debit the wager and further operable to credit proceeds from the wager;
receiving a first video feed from a gaming location, wherein the first video feed includes first live game action images representing first live game action occurring at the gaming location;
receiving corresponding first video metadata with the first video feed, wherein the first video metadata includes electronic information representing the images in the first video feed;
transmitting the first video feed to the user via a broadcaster;
transmitting the first video metadata to a data matching engine;
receiving from the user the wager, wherein the wager includes an amount directed by the user to be placed on the first live game action represented in the first video feed;
receiving by the data matching engine user metadata that includes electronic information representing the wager;
matching by the data matching engine the first video metadata with the user metadata to provide matched metadata; and
executing the wager based on the matched metadata and a rule associated with the live game action.

20. The method of claim 19, further comprising debiting the amount of the wager from the financial account if the user loses or crediting the amount of winnings in connection with the wager if the user wins.

21. The method of claim 19, further comprising:
receiving a second video feed from the gaming location, wherein the second video feed includes second images;
receiving with the second video feed corresponding second video metadata, wherein the second video metadata includes electronic information representing the second images;
transmitting first and second video feeds to the user via the broadcaster;
transmitting the first and second video metadata to the data matching engine; and
displaying the first video feed or the second video feed on a display device for the user and receiving a selection from the user that identifies the first video feed or the second video feed.

22. The method of claim 21, wherein the second images represent at least one selected from the group consisting of: second live game action, an entertainment show, an interview program, a lesson in gaming, shopping areas within the gaming location and customer activity in areas within the gaming location.

23. The method of claim 21, further comprising:
receiving from the user a second wager, wherein the second wager includes an amount directed by the user to be placed on second live game action represented in the second video feed;
receiving by the data matching engine user metadata that includes electronic information representing the second wager;
matching by the data matching engine the second video metadata with the user metadata to provide second matched metadata;
executing the second wager based on the second matched metadata and a rule associated with the second live game action; and
storing the matched metadata and the first video feed in a database.

24. The method of claim 21, further comprising displaying the first video feed in a first portion of the display device and displaying the second video feed simultaneously in a second portion of the display device.

25. The method of claim 19, further comprising receiving from the user a selection to customize the first video feed.

26. The method of claim 25, wherein the selection includes at least one selected from the group consisting of: camera angles, camera zoom factors, audio selections, display colors, character avatar selections, respective game tables and interactive chat display screens.

27. The method of claim 19, further comprising storing the matched metadata and the first video feed in a database.

28. The method of claim 27, further comprising providing user help service wherein the user help service accesses the stored matched metadata and the first video feed.

29. The method of claim 28, wherein the user help service is provided as a virtual pit boss in a casino.

30. The method of claim 19, wherein the first video feed further includes images representing a private winner circle.

31. The method of claim 19, further comprising projecting a virtual playboard for the user, wherein the user places the wager or makes other selections using the virtual playboard.

32. The method of claim 31, further comprising displaying advertisements while the virtual playboard prepares for operation.

33. The method of claim 32, wherein the wager is placed when the user taps a position projected by the virtual playboard.

34. The method of claim 19, further comprising authenticating the user prior to enabling the user to receive the first video feed or prior to the user placing the wager.

35. The method of claim 34, wherein the authenticating comprises receiving an image of the user's fingerprint, wherein the image is generated from a fingerprint reading device before the user receives the first video feed or before the user places the wager.

36. A system for validating a selection made by a user in connection with a remote application, the system comprising:
a video feed from a video source, wherein the video feed includes at least one image;
video metadata that includes electronic information representing the at least one image in the video feed;
a media asset management server operable to receive the video feed and the video metadata, and further operable to transmit the video feed to the user via a broadcaster;
a data matching engine operable to receive from the media asset management server the video metadata;
a user selection device operable to receive a selection from the user that is responsive to the video feed;
user metadata that includes electronic information representing the selection and that is transmitted from the user selection device to the data matching engine, wherein the data matching engine matches the video metadata with the user metadata to provide matched metadata, and further wherein the user's selection is validated as a function of cross-referencing the matched metadata and the video feed.

37. The system of claim 36, wherein the broadcaster is a multiple system operator.

38. The system of claim 36, further comprising a television set top box that receives the selection from the user selection device.

39. The system of claim 38, wherein the television set top box is OpenCable Applications Platform compliant and the selection is formatted to be data over Cable Service Interface Specification protocol compliant.

40. The system of claim 36, wherein the video metadata represents a time, transmission and location corresponding to the at least one image.

41. The system of claim 36, wherein the user metadata represents an identification of the user, the location of the user and the time the selection is made.

42. The system of claim 41, wherein the at least one image represents live game action and the selection represents a wager placed by the user on the live game action.

43. The system of claim 42, wherein the user metadata further represents the amount of the wager.

44. The system of claim 36, wherein personally identifiable information from the user is received by the media asset management server prior to the user receiving the video feed, wherein the personally identifiable information is not included the user metadata.

45. The system of claim 44, wherein the media asset management server receives the matched metadata from the data matching engine, and matches the matched metadata with the personally identifiable information.

46. The system of claim 36, further comprising a database that stores the matched metadata and the video feed.

47. The system of claim 36, wherein the video feed includes an audio portion.

48. A method for validating a selection made by a user in connection with a remote application, the method comprising:
transmitting first content to the user using a first data communication protocol;
receiving second content from the user using a second and distinct data communication protocol, wherein the second content includes the selection; and
cross-referencing the first content and the second content to validate the selection.
